(19) United States
(12) Patent Application Publication
(10) Pub. No.: US 2008/0143907 A1
(43) Pub. Date: Jun. 19, 2008

(54) LIQUID CRYSTAL DISPLAY DEVICE AND METHOD OF MANUFACTURING THE SAME

(75) Inventors: Kwang-Hyun KIM, Guri-si (KR); Sung-Kyu HONG, Seongnam-si (KR); Nam-Seok LEE, Suwon-si (KR); Ho-Yun BYUN, Hwaseong-si (KR); Sung-Hwan HONG, Suwon-si (KR); Min-Jae KIM, Suwon-si (KR); Kyong-Ok PARK, Bucheon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/957,023

(22) Filed: Dec. 14, 2007

(30) Foreign Application Priority Data
Dec. 19, 2006 (KR) 10-2006-0129827

(51) Int. Cl. G02F 1/136; G02F 1/13

(52) U.S. Cl. 349/43; 349/187

(57) ABSTRACT

The liquid crystal display device according to the present invention includes a substrate having a plurality of pixel areas, a pixel electrode disposed in each pixel area, a thin film transistor (TFT) connected to the pixel electrode to selectively apply a display signal, and a signal line connected to the TFT to apply a signal. The signal line includes an electric field changing pattern projecting toward the pixel electrode.

### CROSS-REFERENCE TO RELATED APPLICATION

The present application claims priority from and the benefit of Korean Patent Application No. 10-2006-0129827, filed on Dec. 19, 2006, which is hereby incorporated by reference for all purposes as if fully set forth herein.

### BACKGROUND OF THE INVENTION

1. Field of the Invention

The present invention relates to a liquid crystal display (LCD) device and a method of manufacturing the same, more particularly, to an LCD device that may prevent light leakage caused by a lateral field generated between a data line and a pixel electrode without reducing the aperture ratio, and a method of manufacturing the LCD device.

2. Discussion of the Background

A liquid crystal display (LCD) device displays an image by adjusting the light transmissivity of liquid crystal molecules having dielectric anisotropy using an electric field. Accordingly, an LCD device includes an LCD panel to display images through a liquid crystal cell matrix and a driving circuit to drive the LCD panel.

The LCD panel may include a color filter substrate, a thin film transistor (TFT) substrate, and a liquid crystal layer disposed between the two substrates. The TFT substrate may include a gate line and a data line crossing each other to define a pixel area. A TFT, which is a switching element, may be formed in each pixel area defined by the gate line and the data line. Moreover, a pixel electrode connected to the TFT to receive a pixel voltage and generate an electric field to drive the liquid crystal layer, together with a common electrode formed on the color filter substrate may be formed in each pixel area.

However, a lateral field may be generated in an area between the data line and the pixel electrode, which are arranged adjacent to each other. The lateral field is unlike the vertical electric field that is formed in the pixel area and therefore, may cause light leakage.

In conventional methods, a black matrix may be widened, or a light blocking layer may be provided separately to prevent the light leakage. However, these solutions may reduce the aperture ratio.

### SUMMARY OF THE INVENTION

The present invention provides an LCD device that may prevent light leakage caused by a lateral field generated between a data line and a pixel electrode, and a method of manufacturing the LCD device.

Additional features of the invention will be set forth in the description which follows, and in part will be apparent from the description, or may be learned by practice of the invention.

The present invention discloses a liquid crystal display (LCD) device including a substrate having a plurality of pixel areas, a pixel electrode disposed in each pixel area, a thin film transistor (TFT) connected to the pixel electrode to selectively apply a display signal, and a signal line connected to the TFT to apply a signal. The signal line includes an electric field changing pattern projecting toward the pixel electrode.

The present invention discloses a method of manufacturing a liquid crystal display device, comprising: forming a gate metal pattern including a gate line and a gate electrode on a substrate; forming a gate insulation layer and a semiconductor pattern on the substrate; forming a data metal pattern including a data line, a source electrode, and a drain electrode on the gate insulation layer and the semiconductor pattern; forming a passivation layer on the data metal pattern; and forming a pixel electrode on the passivation layer, wherein one or more signal lines selected from the gate line and the data line has an electric field changing pattern projecting toward the pixel electrode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a plan view showing a display substrate according to an exemplary embodiment of the present invention.

FIG. 2 is a cross-sectional view showing a liquid crystal display device according to an exemplary embodiment of the present invention.

FIG. 3 is a plan view showing a display substrate according to another exemplary embodiment of the present invention.

FIG. 4 is a plan view showing a display substrate according to still another exemplary embodiment of the present invention.

FIG. 5 is a plan view showing a display substrate according to a further exemplary embodiment of the present invention.

FIG. 6 is a view showing a relationship between a polarizing axis of a polarizing plate and a liquid crystal aligned by a lateral field generated between a data line and a pixel electrode.

FIG. 7 is a view showing a relationship between a polarizing axis of a polarizing plate and a liquid crystal layer aligned by a lateral field generated between an electric field changing pattern and a pixel electrode.

FIG. 8 is a cross-sectional view showing a first mask process in a method of manufacturing a display substrate according to an exemplary embodiment of the present invention.

FIG. 9 is a cross-sectional view showing a second mask process in the method of manufacturing a display substrate according to an exemplary embodiment of the present invention.

FIG. 10 is a cross-sectional view showing a third mask process in the method of manufacturing a display substrate according to an exemplary embodiment of the present invention.

FIG. 11 is a cross-sectional view showing a fourth mask process in the method of manufacturing a display substrate according to an exemplary embodiment of the present invention.

FIG. 12 is a cross-sectional view showing a fifth mask process in the method of manufacturing a display substrate according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative size of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening element or layers may be present. In contrast, when an element or layer is referred to as being “directly on” or “directly connected to” another element or layer, there are no intervening elements or layers present.

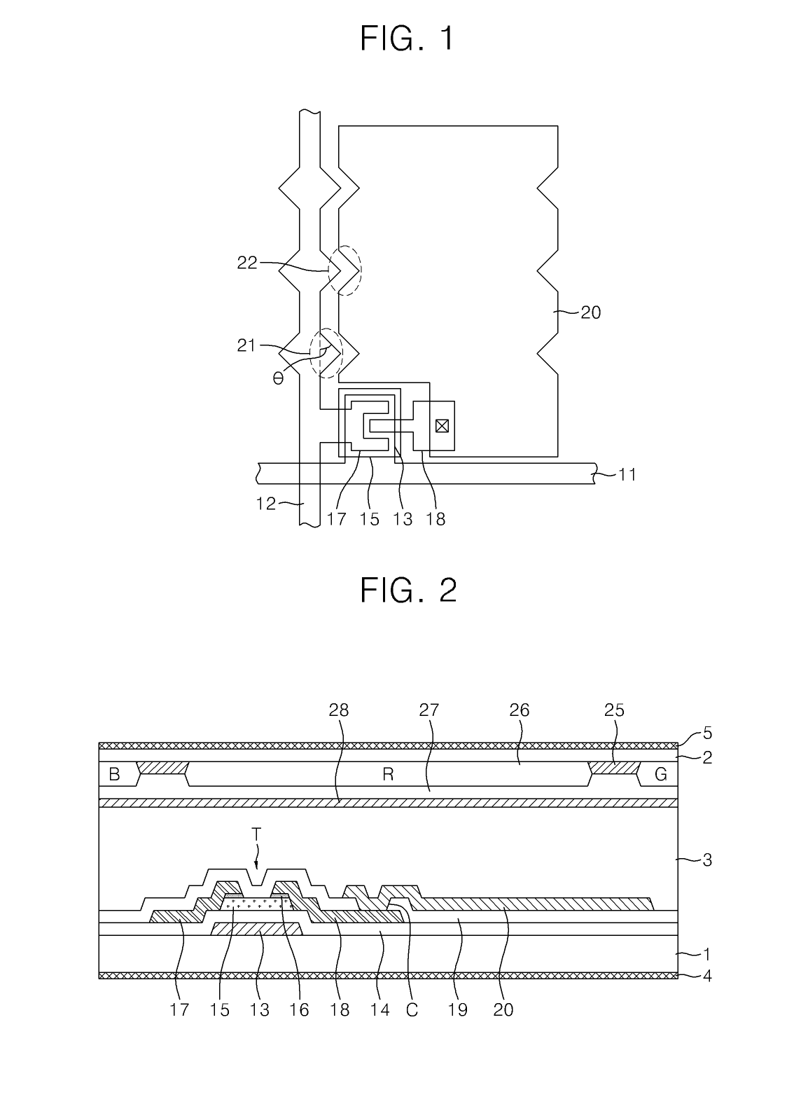

FIG. 1 is a plan view showing a display substrate according to an exemplary embodiment of the present invention, and FIG. 2 is a cross-sectional view showing a liquid crystal display device according to an exemplary embodiment of the present invention.

As shown in FIG. 2, a liquid crystal display (LCD) device includes a display substrate 1, an opposing substrate 2, liquid crystal layer 3, and polarizing plates 4 and 5.

The display substrate 1 includes a plurality of pixel areas arranged in a matrix. Each pixel area includes a thin film transistor (TFT), which is a switching element, and a signal line to apply a signal to the TFT. Moreover, a pixel electrode 20 connected to the TFT to receive a display signal may be provided in each pixel area. The display substrate 1 will be described in more detail below. In the present exemplary embodiment, the signal line includes a data line 12 and a gate line 11.

The gate line 11 provides a scan signal to the TFT. The gate line 11 shown in FIG. 1 is arranged on the display substrate 1. The gate line 11 may be formed of a conductive metal and may have a single layer or a multilayer structure. The gate line 11 is connected to a gate electrode 13 of the TFT.

The data line 12 shown in FIG. 1 is arranged to cross the gate line 11. The pixel area is defined by crossings of the gate lines 11 and the data lines 12. In other words, the pixel areas are formed to have a quadrangle shape defined by adjacent gate lines 11 and adjacent data lines 12. The display signal is applied to the data line 12. The display signal applied to the data line 12 may be delivered to the pixel electrode 20 and charged while a channel of the TFT is turned on by a scan signal provided from the gate line 11.

The data line 12 may be formed of a conductive metal and may have a single layer or a multilayer structure, like the gate line 11.

In this exemplary embodiment, an electric field changing pattern 21 is included in the data line 12 as shown in FIG. 1. The electric field changing pattern 21 changes the direction of a lateral field generated between the data line 12 and the pixel electrode 20.

The data line 12 and the pixel electrode 20 may be arranged substantially parallel to each other. Accordingly, an electric field may be generated between the data line 12 and the pixel electrode 20 in a direction perpendicular the data line 12. When liquid crystal molecules of the liquid crystal layer 3 are horizontally aligned by the lateral field, the liquid crystal molecules are aligned in a direction that is perpendicular to the data line 12 and the same as the lateral field. When the liquid crystal molecules are aligned in a direction perpendicular to the data line 12, light leakage may occur due to the liquid crystal molecules being aligned in a direction perpendicular to the data line 12 while the pixel displays black.

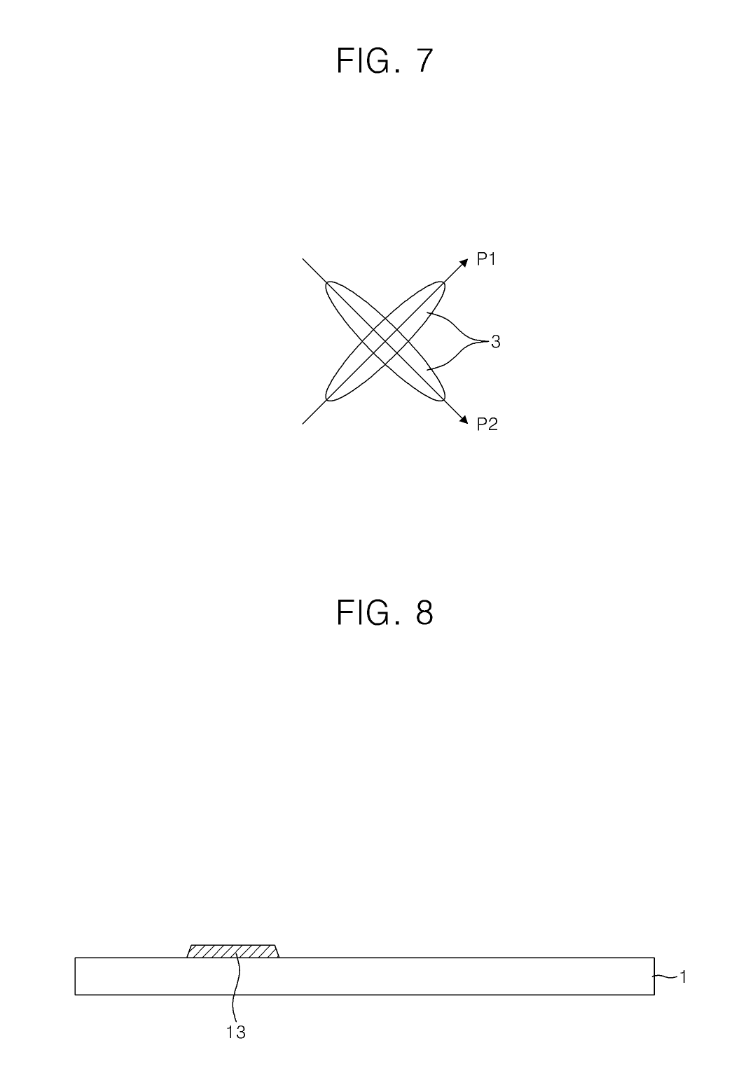

In general, liquid crystal molecules in a twisted nematic (TN) mode are vertically aligned and display black. As shown in FIG. 6 and FIG. 7, a polarizing axis P1 of a first polarizing plate 4 attached to a rear side of the display substrate 1 and a polarizing axis P2 of a second polarizing plate 5 attached to a rear side of the opposing substrate 2 may be arranged perpendicular to each other. Accordingly, since the light, which is not polarized by the vertically aligned liquid crystal molecules of the liquid crystal layer 3, cannot pass through the LCD device due to the polarizing axes of the polarizing plates, which are attached perpendicular to each other, and blackness is displayed.

However, the light polarized by the liquid crystal molecules aligned perpendicular to the data line 12 passes through the two polarizing plates 4 and 5 arranged perpendicular to each other and therefore, may cause light leakage.

In this exemplary embodiment, the lateral field generated by the data line 12 and the pixel electrode 20 may be maintained, whereas, the horizontal direction of the lateral field may be changed using the electric field changing pattern 21. That is, as shown in FIG. 1, the electric field changing pattern 21 projecting toward the pixel electrode 20 may be formed such that the width of existing data line 12 is maintained. For example, the electric field changing pattern 21 may be formed on one side of the data line 12 or on both sides of the data line 12.

The electric field changing pattern 21 may be formed in a polygonal shape having a side parallel to the polarizing axis of the polarizing plate. The polarizing axis of the polarizing plate may represent an axis parallel to a vibration direction that light can pass through the polarizing plate. When the side of the electric field changing pattern 21 is formed parallel to the polarizing axis P1 of one polarizing plate 4, the electric field formed by the electric field changing pattern 21 is parallel to the polarizing axis P2 of the other polarizing plate 5. Accordingly, a polarizing axis of the horizontally aligned liquid crystal molecules of the liquid crystal layer 3 meets the polarizing axes P1 and P2 of the polarizing plates 4 and 5, as shown in FIG. 7, which may prevent light leakage.

In general, in the TN mode, the polarizing plates 4 and 5 may be attached to the substrates 1 and 2 so that the polarizing axes P1 and P2 of the polarizing plates 4 and 5 are parallel to the diagonal direction of the substrates 1 and 2. Thus, as shown FIG. 1, the side of the electric field changing pattern 21 may be formed to have an angle θ of about 45° with respect to the data line 12. Of course, it is suitable that the formation direction of the side of the electric field changing pattern 21 be changed along the arrangement direction of the polarizing axes P1 and P2 of the polarizing plates 4 and 5.

It may be possible to form the electric field changing pattern 21 in various shapes. For example, the electric field changing pattern 21 may be a triangle and the base of the triangle may correspond to an outer line of the data line 12 as shown in FIG. 1. The triangle may be an isosceles triangle and the interior angle θ formed by the outer line of the data line 12 may be, for example, about 45°.

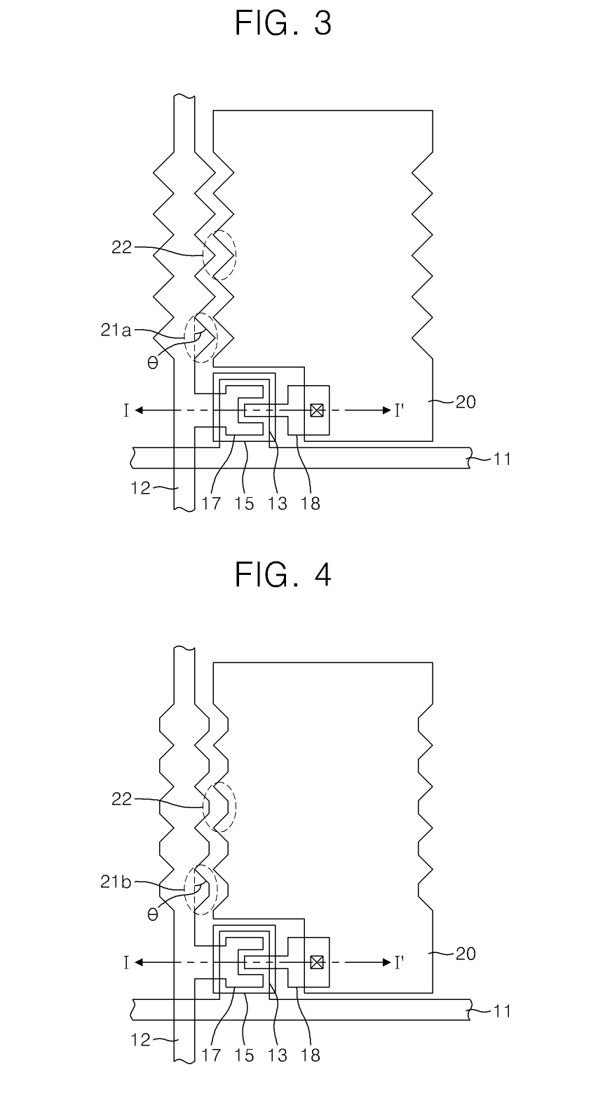

Moreover, a plurality of electric field changing patterns 21 may be spaced apart from each other at regular intervals as shown in FIG. 1, or arranged immediately adjacent to one another as shown in FIG. 3. However, if the portion of the data line 12 that is parallel to the pixel electrode 20 is reduced, light leakage may be effectively prevented. Accordingly, the electric field changing patterns 21a may be arranged immediately adjacent to one another as shown in FIG. 3.

As shown in FIG. 4, an electric field changing pattern 21b may be a trapezoid having a base corresponding to an outer line of the data line 12. The trapezoid may be an isosceles trapezoid and the angle θ formed by the outer line of the data line 12 may be, for example, about 45° so that the liquid crystal molecules may be aligned parallel to the polarizing axes P1 and P2 of polarizing plates 4 and 5.

Alternatively, the electric field changing pattern 21b may be formed in the gate line 11. Since the gate line 11 faces the pixel electrode 20 along with a plurality of insulation layers disposed therebetween, the gate line 11 does not generate a lateral field as strong as that of the data line 12, but still generates a lateral field to some degree. Accordingly, it may be possible to prevent light leakage caused by the gate electrode 13 by forming the electric field changing pattern 21b in the gate line 11.

The TFT includes a gate electrode 13, a semiconductor layer 15, an ohmic contact layer 16, a source electrode 17, and a drain electrode 18. The gate electrode 13 is connected to the gate line 11 and arranged on the display substrate 1 as shown in FIG. 2. Of course, the gate electrode 13 may be arranged on the source and drain electrodes of the TFT.

The semiconductor layer 15 overlaps the gate electrode 13 along with a gate insulation layer 14 disposed therebetween. The semiconductor layer 15 includes polysilicon, amorphous silicon, or the like. When a scan signal is applied to the gate electrode 13, the semiconductor layer 15 forms a channel to transmit a display signal applied from the source electrode 17 to the drain electrode 18.

The ohmic contact layer 16 is formed on the semiconductor layer 15. The ohmic contact layer 16 comprises polysilicon doped with impurities, amorphous silicon, or the like. The ohmic contact layer 16 forms an ohmic contact between the semiconductor layer 15 and the source electrode 17 or between the semiconductor layer 15 and the drain electrode 18 to improve characteristics of the TFT.

One end of the source electrode 17 is connected to the data line 12 as shown in FIG. 1, and the other end of the source electrode 17 overlaps a portion of the semiconductor layer 15 as shown in FIG. 2. Meanwhile, one end of the drain electrode 18 is connected to the pixel electrode 20 as shown in FIG. 1, and the other end of the drain electrode 18 overlaps a portion of the semiconductor layer 15 as shown in FIG. 2.

The pixel electrode 20 is connected to the drain electrode 18 through a contact hole C, as shown in FIG. 2, to receive the display signal from the drain electrode 18. The pixel electrode 20 includes a transparent conductive layer to allow light provided from a backlight unit to pass. Accordingly, the pixel electrode 20 may be formed of indium tin oxide (ITO), indium zinc oxide (IZO), indium tin zinc oxide (ITZO), or the like.

In this exemplary embodiment, as shown FIG. 1, a pattern 22 may be formed in the pixel electrode 20. The pattern 22 may be formed on a surface adjacent to the data line 12 on the sides of the pixel electrode 20 and may have a shape corresponding to that of the electric field changing pattern 21. Accordingly, if the electric field changing pattern 21 has a triangular shape, the pattern 22 may be formed with a groove having a triangular shape. On the other hand, if the electric field changing pattern 21 has a rectangular shape, the pattern 22 may be formed with a groove having a rectangular shape.

With the pattern 22 formed in the pixel electrode 20, a lateral field is more readily formed between the data line 12 and the pixel electrode 20 in a direction parallel to a polarizing axis of a polarizing plate. Thus, it may be possible to prevent light leakage generated between the data line 12 and the pixel electrode 20.

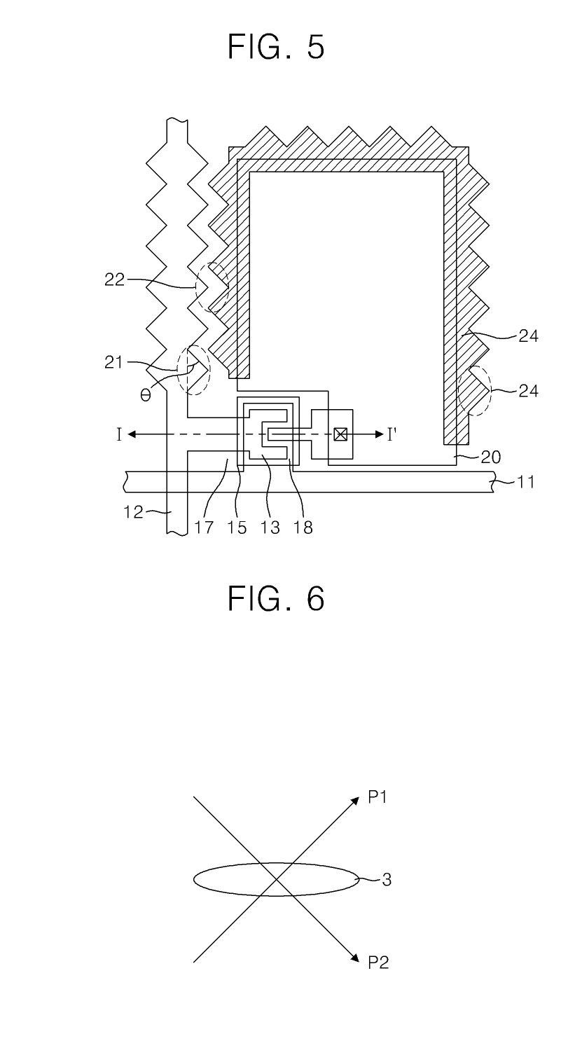

In this exemplary embodiment, as shown in FIG. 5, the display substrate 1 may further include a light blocking layer 23. The light blocking layer 23 blocks the light emitted from the backlight unit between the pixel electrode 20 and the data line 12. The light blocking layer 23 includes an opaque layer that does not transmit light. In this exemplary embodiment, the light blocking layer 23 may be formed of the same metal layer as the gate line 11. Since voltage is not applied to the light blocking layer, the light blocking layer 23 is in an electrically floating state.

A pattern 24 may also be formed on the light blocking layer 23 as shown in FIG. 5. If the pattern 24 is formed on the light blocking layer 23, the pixel electrode 20 need not include the pattern 22. Alternatively, the patterns 22 and 24 may be formed on both the light blocking layer 23 and the pixel electrode 20, respectively.

Since the shape of the pattern 24 is substantially identical to that of the pattern 22 of the pixel electrode 20, its description will be omitted.

The opposing substrate 2 includes a black matrix 25, color filters 26, an overcoat layer 27, and a common electrode 28. The black matrix 25 may be formed of an opaque layer that does not transmit light. The black matrix 25 defines areas on the opposing substrate 2 corresponding to the pixel areas. The color filters 26 are formed in the areas defined by the black matrix 25. In this case, adjacent color filters 26 may have different colors.

The overcoat layer 27 is formed on the black matrix 25 and the color filters 26 to planarize the surface of the opposing substrate 2. The overcoat layer 27 may be formed of an organic material.

The common electrode 28 may be formed on the overcoat layer 27. A common voltage, which is a reference voltage for driving the liquid crystal layer 3, may be applied to the common electrode 28. The common electrode 28, like the pixel electrode 20, may be formed of a transparent conductive layer that transmits light.

Hereinafter, a method of manufacturing a display substrate according to an exemplary embodiment of the present invention will be described.

FIG. 8 is a cross-sectional view showing a first mask process in a method of manufacturing a display substrate according to an exemplary embodiment of the present invention.

A gate metal pattern including a gate line 11 and a gate electrode 13 is formed on a substrate 1 through a first mask process.

In more detail, the gate metal layer may be formed on the substrate 1 through a deposition process, such as sputtering. The gate metal layer may be formed of at least one of molybdenum (Mo), titanium (Ti), copper (Cu), aluminum-neodymium (AlNd), aluminum (Al), chromium (Cr), and an alloy thereof and may have a single layer or a multilayer structure. The gate metal pattern including the gate line 11 and the gate electrode 13 may be formed by patterning the gate metal layer through a photolithography process and an etching process using a first mask.

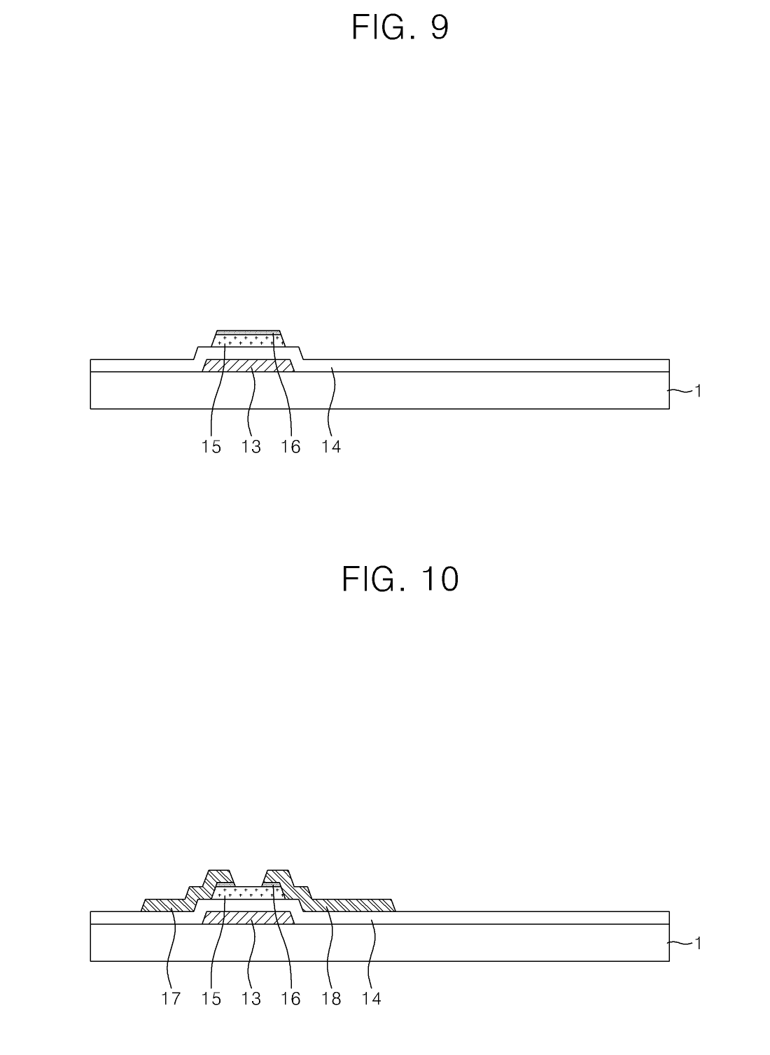

FIG. 9 is a cross-sectional view showing a second mask process in the method of manufacturing a display substrate according to an exemplary embodiment of the present invention.

A gate insulation layer 14 is formed on the substrate 1 on which the gate metal pattern is formed and, then, a semiconductor pattern is formed on the gate insulation layer 14 by a second mask process. In more detail, the gate insulation layer 14, an amorphous silicon layer, and an amorphous silicon layer doped with impurities (n+ or p+) may be sequentially formed on the substrate 1 on which the gate metal pattern is formed. The gate insulation layer 14, the amorphous silicon layer, and the amorphous silicon layer doped with impurities may, for example, be formed by plasma enhanced chemical vapor deposition (PECVD). The gate insulation layer 14 may be formed of an inorganic insulation layer, such as silicon oxide (SiOx), silicon nitride (SiNx), or the like. Subsequently, a semiconductor layer 15 and an ohmic contact layer 16 may be formed by patterning the amorphous silicon layer and the amorphous silicon layer doped with impurities by a photolithography process and an etching process using a second mask.

FIG. 10 is a cross-sectional view showing a third mask process in the method of manufacturing a display substrate according to an exemplary embodiment of the present invention.

A data metal pattern, including a data line 12, a source electrode 17, and the drain electrode 18, is formed on the substrate 1 on which the semiconductor layer 15 and the ohmic contact layer 16 are formed. The data metal layer may be formed on the substrate 1 by a deposition process, such as sputtering. The data metal layer may be formed of at least one of molybdenum (Mo), titanium (Ti), copper (Cu), aluminum neodymium (AlNd), aluminum (Al), chromium (Cr), and an alloy thereof and may have a single layer or a multilayer structure. Subsequently, a photoresist may be applied on the data metal layer and, then, the data metal pattern, including the data line 12, the source electrode 17, and the drain electrode 18, may be formed by a photolithography process and an etching process using a third mask.

In this exemplary embodiment, the third mask for patterning the data line 12 may be configured to have a shape that forms an electric field changing pattern in the data line 12. Accordingly, the present exemplary embodiment provides a display substrate that may prevent light leakage without complicating the manufacturing process.

The above-described second and third mask processes may be combined into a single mask process. That is, a stepped photoresist pattern may be formed using a half-tone mask or a slit mask, and then the data metal pattern and the semiconductor pattern may be sequentially formed using the stepped photoresist pattern.

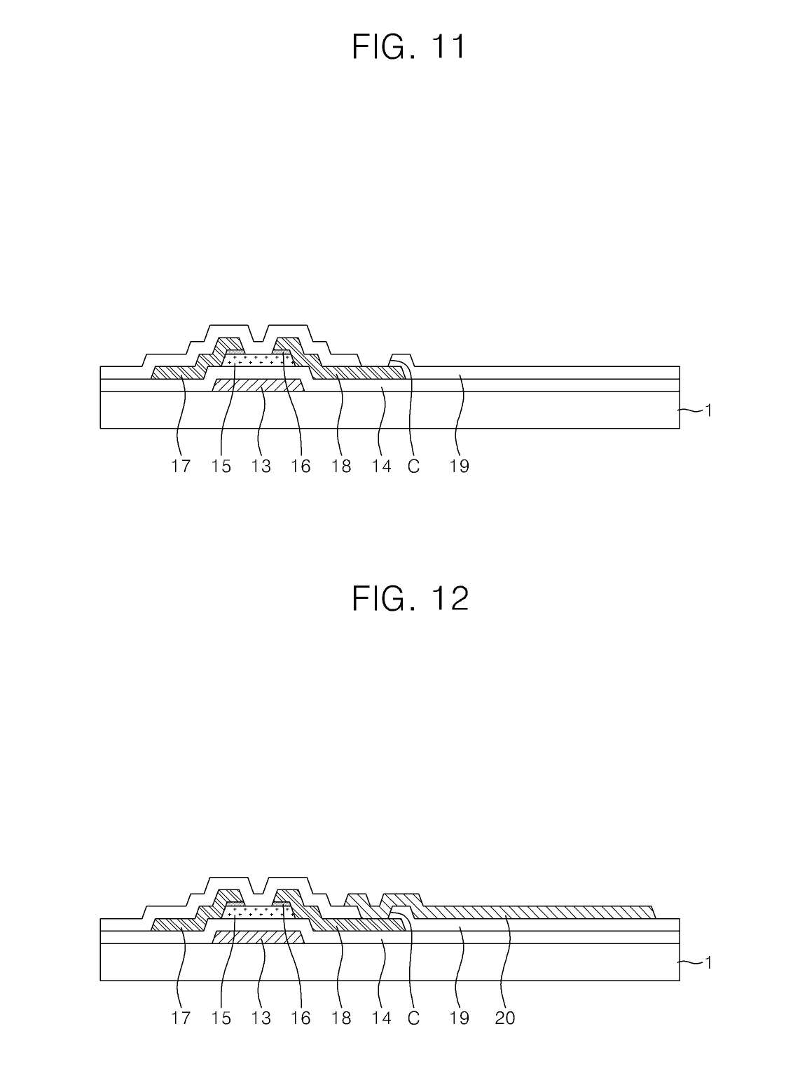

FIG. 11 is a cross-sectional view showing a fourth mask process in the method of manufacturing a display substrate according to an exemplary embodiment of the present invention.

A passivation layer 19 including a contact hole C is formed by a fourth mask process. In more detail, the passivation layer 19 may be formed on the gate insulation layer 14, on which the data metal pattern is formed, by PECVD, spin coating, spinless coating, or the like, as shown in FIG. 11. The passivation layer 19 may be an inorganic insulation layer, which may include the same material as the gate insulation layer and may be formed by CVD, PECVD, or the like. Alternatively, the passivation layer 19 may include an organic insulating material, such as an acryl based organic compound, BCB, PFCB, or the like, and may be formed by spin coating, spinless coating, or the like. As yet another alternative, the passivation layer 19 may be a double structure including an inorganic insulation layer and an organic insulation layer. Subsequently, a photoresist may be applied to the passivation layer 19 and then exposed and developed by a photolithography process using a fourth mask, thus forming a photoresist pattern in an area where the passivation layer 19 is to be formed. Next, the contact hole C may be formed by patterning the passivation layer 19 through an etching process using the photoresist pattern.

FIG. 12 is a cross-sectional view showing a fifth mask process in the method of manufacturing a display substrate according to an exemplary embodiment of the present invention.

A pixel electrode 20 may be formed on the passivation layer 19 by a fifth mask process. In more detail, a transparent conductive layer may be formed on the passivation layer 19, including the contact hole C, by a deposition process, such as sputtering. The transparent conductive layer may be formed of ITO, TO, IZO, SnO₂, a-ITO, or the like.

The pixel electrode 20 may be formed by patterning the transparent conductive layer through a photolithography process and an etching process using a fifth mask. The pixel electrode 20 may be connected to the drain electrode 18 through the contact hole C.

In this exemplary embodiment, the fifth mask for patterning the pixel electrode 20 may be configured to have a shape that forms a pattern 22 in the pixel electrode 20. Accordingly, the present exemplary embodiment provides a display substrate that may prevent light leakage by changing the shape of the mask.

In accordance with exemplary embodiments of the present invention, in which an electric field changing pattern may be provided in a signal line such as a data line, it may be possible to prevent light leakage by changing the direction of a lateral field generated between the signal line and the pixel electrode. Accordingly, it may be possible to prevent light leakage without reducing the aperture ratio by reducing the length of the black matrix.

Especially, the present invention provides a display substrate that may prevent light leakage by changing the shape of a mask.

It will be apparent to those skilled in the art that various modifications and variations can be made in the present invention without departing from the spirit or scope of the invention. Thus it is intended that the present invention cover the modifications and variations of this invention provided they come within the scope of the appended claims and their equivalents.

What is claimed is:

1. A liquid crystal display device comprising:
a substrate comprising a plurality of pixel areas;
a pixel electrode disposed in each pixel area;
a thin film transistor (TFT) connected to the pixel electrode; and
a signal line connected to the TFT to apply a signal, the signal line comprising an electric field changing pattern projecting toward the pixel electrode.

2. The liquid crystal display device of claim 1, wherein the electric field changing pattern is disposed on both sides of the signal line.

3. The liquid crystal display device of claim 1, wherein the electric field changing pattern is a triangle and the base of the triangle corresponds to an outer line of the signal line.

4. The liquid crystal display device of claim 3, wherein the triangle is an isosceles triangle.

5. The liquid crystal display device of claim 3, wherein the interior angle of the triangle formed by the outer line of the signal line is about 45°.

6. The liquid crystal display device of claim 1, wherein the electric field changing pattern is a trapezoid and the base of the trapezoid corresponds to an outer line of the signal line.

7. The liquid crystal display device of claim 6, wherein the trapezoid is an isosceles trapezoid.

8. The liquid crystal display device of claim 6, wherein the interior angle of the trapezoid formed by the outer line of the signal line is about 45°.

9. The liquid crystal display device of claim 1, wherein the signal line is a data line to transmit the display signal to the TFT.

10. The liquid crystal display device of claim 1, wherein the signal line is a gate line to transmit a scan signal to the TFT.

11. The liquid crystal display device of claim 1, wherein the pixel electrode further comprises a pattern disposed on a surface adjacent to the signal line, the pattern corresponding to the electric field changing pattern.

12. The liquid crystal display device of claim 1, further comprising a light blocking layer disposed between the pixel electrode and the signal line.

13. The liquid crystal display device of claim 12, wherein the light blocking layer further comprises a pattern disposed on a surface adjacent to the signal line, the pattern corresponding to the electric field changing pattern.

14. A method of manufacturing a liquid crystal display device, comprising:
forming a gate metal pattern including a gate line and a gate electrode on a substrate;
forming a gate insulation layer and a semiconductor pattern on the substrate;
forming a data metal pattern including a data line, a source electrode, and a drain electrode on the gate insulation layer and the semiconductor pattern;
forming a passivation layer on the data metal pattern; and
forming a pixel electrode on the passivation layer, wherein
one or more signal lines selected from the gate line and the data line has an electric field changing pattern projecting toward the pixel electrode.

15. The method of claim 14, wherein
the electric field changing pattern is formed on both sides of the signal line.

16. The method of claim 14, wherein
the electric field changing pattern is shaped as a triangle and a base of the triangle corresponds to an outer line of the signal line.

17. The method of claim 16, wherein
the triangle includes an isosceles triangle.

18. The method of claim 14, wherein
the electric field changing pattern is shaped as a trapezoid and a base of the trapezoid corresponds to an outer line of the signal line.

19. The method of claim 18, wherein
the trapezoid includes an isosceles trapezoid.

20. The method of claim 14, wherein
the pixel electrode further comprises a pattern disposed on a surface adjacent to the signal line, the pattern corresponding to the electric field changing pattern.
